(19) United States
(12) Patent Application Publication
(10) Pub. No.: US 2026/0302947 A1
(43) Pub. Date: Oct. 1, 2026

(54) METHOD AND APPARATUS FOR CONTROLLING ADAPTIVE CHARGE-RECOVERY IN SWITCHING REGULATOR

(71) Applicant: Airoha Technology Corp., Hsinchu City (TW)

(72) Inventors: Ke-Deng Huang, Taoyuan City (TW); Chen-Yu Wang, Hsinchu County (TW)

(73) Assignee: Airoha Technology Corp., Hsinchu City (TW)

(21) Appl. No.: 19/458,965

(22) Filed: Jan. 26, 2026

Related U.S. Application Data
(60) Provisional application No. 63/777,702, filed on Mar. 26, 2025.

(51) Int. Cl. H02M 3/158

(52) U.S. Cl. CPC H02M 3/158

(57) ABSTRACT

A controller circuit of a switching regulator includes a constant on-time (COT) setting circuit and a delay time setting circuit. The COT setting circuit adjusts a COT control setting adaptively, wherein an on-time of a high-side power switch of the switching regulator depends on the COT control setting. The delay time setting circuit adjusts a delay time control setting adaptively during a period in which the COT control setting is assigned a minimum COT control value allowed by the switching regulator, wherein a delay time applied to a turn-off time of a low-side power switch of the switching regulator depends on the delay time control setting.

### CROSS REFERENCE TO RELATED APPLICATIONS

This application claims the benefit of U.S. Provisional Application No. 63/777,702, filed on Mar. 26, 2025. The content of the application is incorporated herein by reference.

### BACKGROUND OF THE INVENTION

### 1. Field of the Invention

The present disclosure relates to a switching regulator design, and more particularly, to a method and apparatus for controlling adaptive charge-recovery in a switching regulator.

### 2. Description of the Prior Art

With advanced development in technology, various electronic products have been presented and are widely used in daily life. In general, a switching regulator is required for providing operating power for an electronic product. The switching regulator may be a buck converter that is capable of converting a high direct current (DC) voltage to a low and stable DC voltage for normal operations of the electronic product. The switching regulator may be employed by an audio device such as Bluetooth (BT) earbuds. When an output voltage of the switching regulator is supplied to a light load (or an extremely light load), the switching frequency F_{SW} of the switching regulator is low, and may induce audible power noise that affects user's auditory experience. To keep the switching frequency F_{SW} above the audio frequency band (i.e., F_{SW}>20 KHz) under the light load condition (or the extremely light load condition), a typical solution is adding a dummy load to an output node of the switching regulator. However, the additional dummy load will cause energy loss, resulting in poor efficiency under the light load condition (or the extremely light load condition).

### SUMMARY OF THE INVENTION

One of the objectives of the present disclosure is to provide a method and apparatus for controlling adaptive charge-recovery in a switching regulator.

According to a first aspect of the present invention, an exemplary controller circuit of a switching regulator is disclosed. The exemplary controller circuit includes a constant on-time (COT) setting circuit and a delay time setting circuit. The COT setting circuit is configured to adaptively adjust a COT control setting, wherein an on-time of a high-side power switch of the switching regulator depends on the COT control setting. The delay time setting circuit is configured to adaptively adjust a delay time control setting during a period in which the COT control setting is assigned a minimum COT control value allowed by the switching regulator, wherein a delay time applied to a turn-off time of a low-side power switch of the switching regulator depends on the delay time control setting.

According to a second aspect of the present invention, an exemplary method for controlling a switching regulator is disclosed. The exemplary method includes: adaptively adjusting a constant on-time (COT) control setting, wherein an on-time of a high-side power switch of the switching regulator depends on the COT control setting; and adaptively adjusting a delay time control setting during a period in which the COT control setting is assigned a minimum COT control value allowed by the switching regulator, wherein a delay time applied to a turn-off time of a low-side power switch of the switching regulator depends on the delay time control setting.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a switching regulator according to an embodiment of the present invention.

FIG. 2 is a diagram illustrating a normal COT regulation operation and a CB-mode regulation operation according to an embodiment of the present invention.

FIG. 3 is a diagram illustrating a counter-based adaptive adjustment algorithm employed by a controller circuit of a switching regulator according to an embodiment of the present invention.

FIG. 4 is a diagram illustrating a controller circuit of a switching regulator according to an embodiment of the present invention.

FIG. 5 is a flowchart illustrating a method for controlling a switching regulator according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

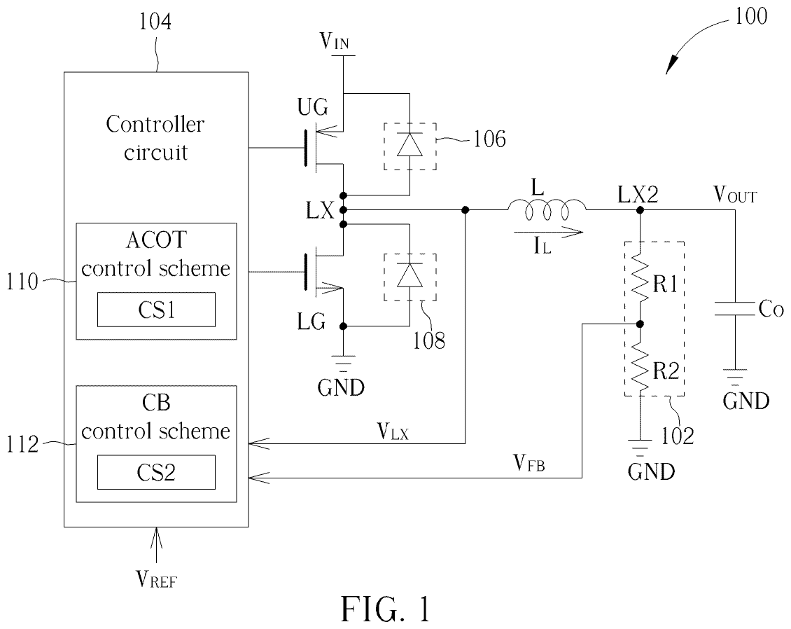

FIG. 1 is a diagram illustrating a switching regulator according to an embodiment of the present invention. The switching regulator 100 is a voltage converter such as a buck converter. In this embodiment, the switching regulator 100 is designed for converting an input voltage V_{IN} into an output voltages V_{OUT} (e.g., V_{OUT}<V_{IN}). The input voltage V_{IN} may be supplied from a power source such as a battery. The output voltage V_{OUT} is supplied to a load device (not shown). The load device may be any electronic device that consumes electricity. The switching regulator (e.g., buck converter) 100 includes an inductor L, a high-side power switch UG, a low-side power switch LG, a feedback circuit 102, an output capacitor C_{O}, and a controller circuit (e.g., buck controller) 104.

The high-side power switch UG may be implemented using a P-channel metal-oxide-semiconductor (PMOS) transistor. The low-side power switch LG may be implemented using an N-channel metal-oxide-semiconductor (NMOS) transistor. Due to inherent characteristics of the PMOS transistor, the high-side power switch UG has a body diode 106 with an anode coupled to a drain terminal and a cathode coupled to a source terminal. Due to inherent characteristics of the NMOS transistor, the low-side power switch LG has a body diode 108 with an anode coupled to a source terminal and a cathode coupled to a drain terminal. The high-side power switch UG and the low-side power switch LG are series-connected between a first voltage node (e.g., input voltage V_{IN}) and a second voltage node (e.g., ground voltage GND). Specifically, the high-side power switch UG is coupled between the first voltage node (e.g., input voltage V_{IN}) and a switching node LX, and the low-side power switch LG is coupled between the switching node LX and the second voltage node (e.g., ground voltage GND). The inductor L has a first end coupled to the switching node LX, and has a second node coupled to a switching node LX2. An inductor current I_{L} flowing through the inductor L is defined to have a positive polarity when the inductor current I_{L} flows in a forward direction LX→LX2 that would transfer energy to the load device. The inductor current I_{L} flowing through the inductor L is defined to have a negative polarity when the inductor current I_{L} flows in a backward direction LX2→LX opposite to the forward direction LX→LX2.

The controller circuit 104 is configured to control an ON/OFF state of each of the high-side power switch UG and the low-side power switch LG for V_{OUT} regulation. The feedback circuit 102 is configured to generate a feedback voltage V_{FB} according to the output voltage V_{OUT} of the switching regulator 100. In this embodiment, the feedback circuit 102 is implemented by a voltage divider with series-connected resistors R1 and R2 between the output voltage V_{OUT} and a reference terminal (e.g., ground voltage GND). The resistance values of the resistors R1 and R2 may be set in accordance with practical requirements. The feedback circuit 102 is configured to perform voltage division upon the output voltage V_{OUT} to generate a divided voltage as the feedback voltage V_{FB}, and provides the feedback voltage V_{FB} to the controller circuit 104. Since the feedback voltage V_{FB} is positively correlated with the output voltage V_{OUT}, the controller circuit 104 is aware of the instant status of the output voltage V_{OUT}. Alternatively, the feedback voltage V_{FB} may be directly set by the output voltage V_{OUT}. To put it simply, the feedback voltage V_{FB} may be set by any voltage signal derived from the output voltage V_{OUT}. The controller circuit 104 may further receive a voltage V_{LX} at the switching node LX. The ON state of the high-side power switch UG may be triggered based on the feedback voltage V_{FB}

$$( {V}_{FB} = {V}_{OUT} * \frac{R 2}{R 1 + R 2} or {V}_{FB} = {V}_{OUT} ) .$$

The OFF state of the low-side power switch UG may be triggered based on the voltage V_{LX}.

The switching regulator 100 may be configured to adopt an adaptive constant on-time (ACOT) control scheme under a discontinuous current mode (DCM). In this embodiment, the controller circuit 104 may support a plurality of control schemes, including a typical ACOT control scheme 110 and a proposed charge back (CB) control scheme 112. The proposed CB control scheme 112 is enabled when certain criteria are met.

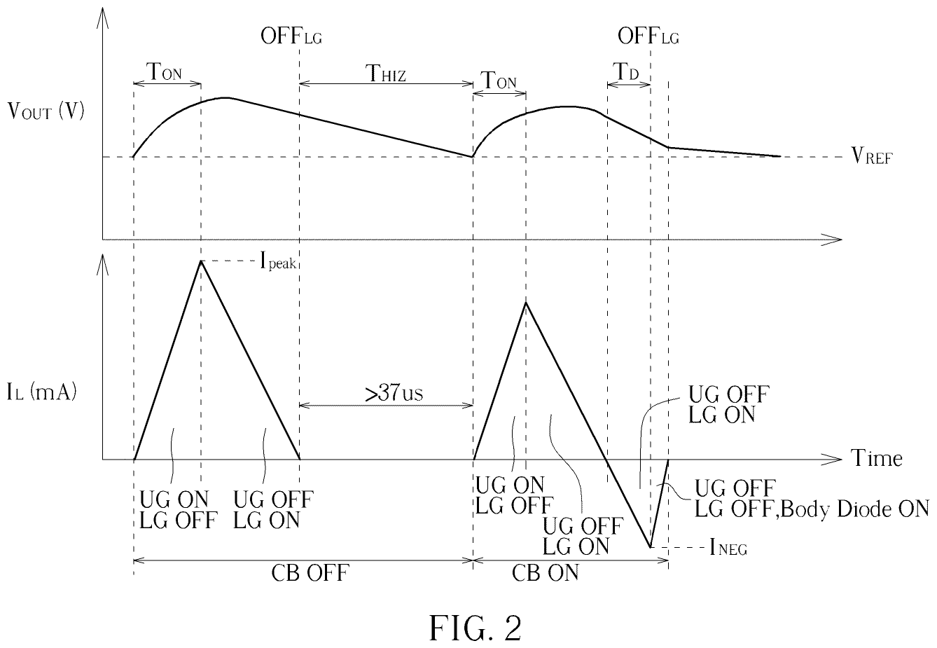

FIG. 2 is a diagram illustrating a normal COT regulation operation and a CB-mode regulation operation according to an embodiment of the present invention. Suppose that the output voltage V_{OUT} is fed back to serve as the feedback voltage V_{FB} needed by the controller circuit (e.g., buck controller) 104. Regarding the normal COT regulation operation, the controller circuit 104 compares the feedback voltage V_{FB} with a reference voltage V_{REF} (which is a target voltage level of the regulator output). When the output voltage V_{OUT} is lower than the reference voltage V_{REF}, the controller circuit 104 turns on the high-side power switch UG to start one regulation operation. The ACOT control scheme 110 has a COT control setting CS1 which is set to control an on-time T_{ON} of the high-side power switch UG. After the on-time T_{ON} expires, the controller circuit 104 turns off the high-side power switch UG, and turns on the low-side power switch LG. The controller circuit 104 compares the voltage V_{LX} with the ground voltage GND. When the decreasing voltage V_{LX} reaches the ground voltage GND, meaning that the inductor current I_{L} is a zero current (i.e., I_{L}=0 mA), the controller circuit 104 turns off the low-side power switch LG at the turn-off time OFF_{LG} (i.e., the time instant when V_{LX}=0V). Since both of the high-side power switch UG and the low-side power switch LG are turned off and the inductor current I_{L} is a zero current, the switching regulator 100 enters a High-Z (HiZ) state.

Next, the controller circuit 104 compares the feedback voltage V_{FB} With the reference voltage V_{REF} (which is a target voltage level of the regulator output). When the output voltage V_{OUT} is lower than the reference voltage V_{REF} again, the controller circuit 104 turns on the high-side power switch UG to start another regulation operation. The controller circuit 104 detects that the HiZ time T_{HIZ} between the previous regulation operation and the current regulation operation is larger than a threshold value (e.g., 37 us), implying that the switching frequency F_{SW} is close to an upper bound of the audio frequency band. Hence, the controller circuit 104 enables the CB control scheme 112. It should be noted that the threshold value set by 37 us is for illustrative purposes only, and is not meant to be a limitation of the present invention. The HiZ time T_{HIZ} that reaches the threshold value implies that the switching frequency F_{SW} above the audio frequency band is close to the upper bound (e.g., 20 KHz) of the audio frequency band now. In practice, the setting of the threshold value may depend on actual design considerations.

After the on-time T_{ON} expires, the controller circuit 104 turns off the high-side power switch UG, and turns on the low-side power switch LG. The controller circuit 104 compares the voltage V_{LX} with the ground voltage GND. When the decreasing voltage V_{LX} reaches the ground voltage GND, meaning that the inductor current I_{L} is a zero current (i.e., I_{L}=0 mA), the CB control scheme 112 does not turn off the low-side power switch LG, allowing the inductor current I_{L} to reverse its polarity and increase its magnitude. The CB control scheme 112 has a delay time control setting CS2 which is set to control a delay time T_{D} applied to the turn-off time OFF_{LG} of the low-side power switch LG. Hence, the inductor current I_{L} becomes a negative inductor current due to the delay time T_{D}. When the delay time T_{D} expires, the controller circuit 104 turns off the low-side power switch LG. After the low-side power switch LG is turned off, the negative inductor current flows back to the power source (e.g., battery) through the body diode 106 of the high-side power switch UG, thereby returning the excess energy (i.e., excess quantity of electric charge) to the power source (e.g., battery). It should be noted that both of the high-side power switch UG and the low-side power switch LG are turned off by the controller circuit 104, and the body diode 106 of the turned-off high-side power switch UG is forward biased for passing the negative inductor current from the inductor L to the power source (e.g., battery). The switching regulator 100 re-enters the HiZ state after the inductor current I_{L} becomes a zero current (i.e., I_{L}=0 mA) under a condition that both of the high-side power switch UG and the low-side power switch LG are turned off.

The proposed CB control scheme 112 is enabled when certain criteria are met. For example, the switching regulator 100 does not enter the CB mode unless the HiZ time T_{HIZ} between the previous regulation operation and the current regulation operation is larger than the threshold value (e.g., 37 us) and the COT control setting CS1 is assigned a minimum COT control value (which corresponds to a minimum peak current Iₚₑₐₖ of the inductor L that is allowed by the switching regulator 100 due to hardware limitations). In addition, the proposed CB control scheme 112 is disabled when certain criteria are met. For example, the switching regulator 100 does not leave the CB mode unless the delay time control setting CS2 is assigned a minimum delay time control value (which corresponds to a minimum delay time (e.g., T_{D}=0 us) that is allowed by the switching regulator 100). Specifically, the COT control setting CS1 is initialized/reset by a maximum COT control value (which corresponds to a maximum peak current Iₚₑₐₖ of the inductor L that is allowed by the switching regulator 100 due to hardware limitations), and the delay time control setting CS2 is initialized/reset by the minimum delay time control value (which corresponds to the minimum delay time (e.g., T_{D}=0 us) that is allowed by the switching regulator 100).

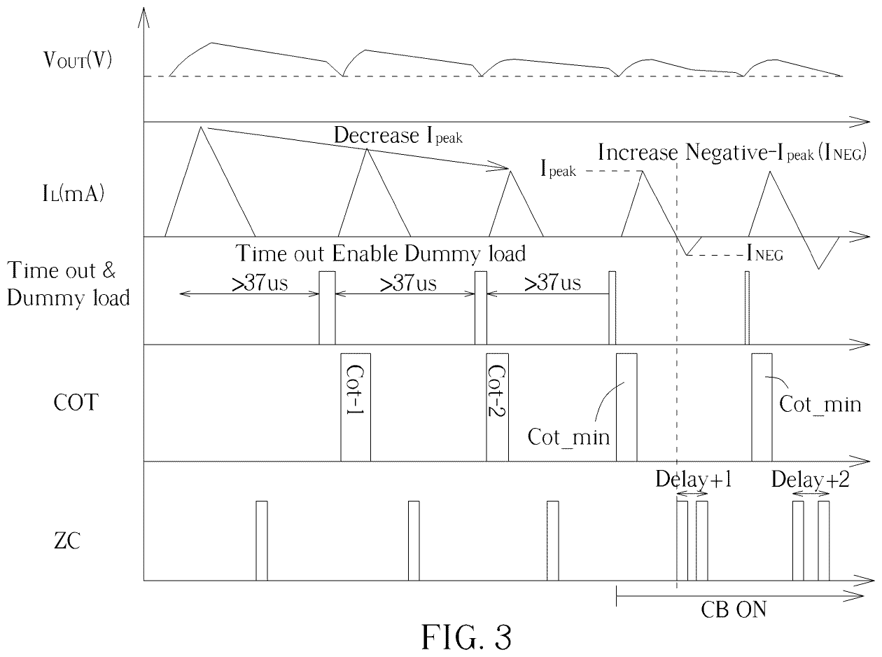

In this embodiment, the controller circuit 104 employs a counter-based adaptive adjustment algorithm for adaptively adjusting the COT control setting CS1 and the delay time control setting CS2. For example, the delay time control setting CS2 is adaptively adjusted during a period in which the COT control setting CS1 is assigned the minimum COT control value allowed by the switching regulator 100. Hence, the delay time control setting CS2 is a control code that is adjusted by one adjustment value (e.g., +1 or −1) per each CB-mode regulation operation. FIG. 3 is a diagram illustrating the counter-based adaptive adjustment algorithm employed by the controller circuit 104 according to an embodiment of the present invention. When the switching frequency F_{SW} is lower than a threshold value, making the HiZ time longer than 37 us, the dummy load will be activated periodically at a fixed clock rate, and the positive peak current Iₚₑₐₖ will be reduced by adaptively adjusting (decreasing) the COT control setting CS1. Once the positive peak current Iₚₑₐₖ is reduced to its minimum due to the COT control setting CS1 assigned with the minimum COT control value Cot_min and the HiZ time is still longer than 37 us, the ZC delay time will start to increase in a stepwise manner, causing the inductor's negative peak current I_{NEG} to rise until the load and the inductor current reach equilibrium. Further details of the counter-based adaptive adjustment algorithm are described as below with reference to the accompanying drawings.

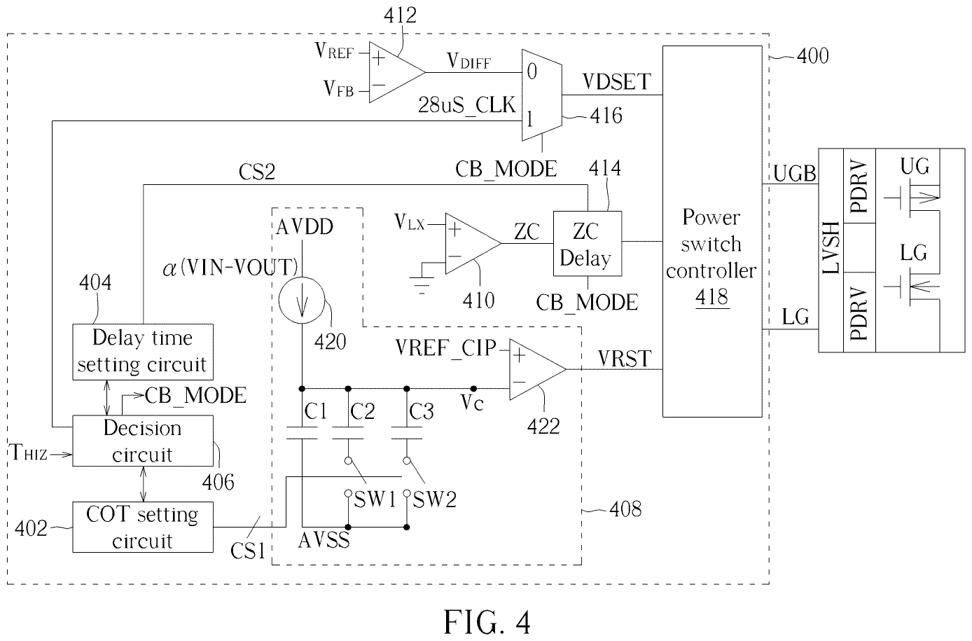

FIG. 4 is a diagram illustrating a controller circuit of a switching regulator according to an embodiment of the present invention. The controller circuit 104 shown in FIG. 1 may be implemented using the controller circuit 400. The controller circuit 400 includes a COT setting circuit 402, a delay time setting circuit 404, a decision circuit 406, an on-time generator 408, comparators 410, 412, a controllable delay circuit (labeled by ZC delay) 414, a multiplexer 416, and a power switch controller 418. The COT setting circuit 402 is configured to adaptively adjust the COT control setting CS1, wherein an on-time T_{ON} of the high-side power switch UG of the switching regulator 100 depends on the COT control setting CS1. The delay time setting circuit 404 is configured to adaptively adjust a delay time control setting CS2 during a period in which the COT control setting CS1 is assigned the minimum COT control value allowed by the switching regulator 100, wherein the delay time T_{D} applied to the turn-off time OFF_{LG} of the low-side power switch LG of the switching regulator 100 depends on the delay time control setting CS2. The decision circuit 406 is configured to monitor the HiZ time T_{HIZ} between two successive regulation operations, and asserts the control signal CB_MODE (CB_MODE=1) to enable the CB mode. The decision circuit 406 acts as a normal-mode controller and a CB-mode controller. For example, the decision circuit 406 is further configured to monitor the HiZ time T_{HIZ} for instructing one or both of the COT setting circuit 402 and the delay time setting circuit 404 to adjust one or both of the COT control setting CS1 and the delay time control setting CS2. The switching regulator 100 leaves the CB mode at a delay time control value of the time the delay time control setting CS2 decreases to a minimum value that corresponds to the minimum delay time (e.g., T_{D}=0 us).

When the CB mode is inactive (i.e., CB_MODE=0), the multiplexer 416 selects a comparator output VDIFF of the comparator 412 as a control input VDSET of the power switch controller 418. The control input VDSET determines the turn-on time of the high-side power switch UG. Specifically, the control input VDSET controls whether to start one regulation operation of the output voltage V_{OUT}. When the feedback voltage V_{FB} is higher than the reference voltage V_{REF}, the control input VDSET has a logic low level, and the high-side power switch UG is not turned on. However, when the feedback voltage V_{FB} drops below the reference voltage V_{REF}, the control input VDSET has a logic high level, and the high-side power switch UG is turned on. When the CB mode is active (i.e., CB_MODE=1), the multiplexer 416 selects a fixed clock 28 uS_CLK (i.e., a 35 KHz clock with a 28 us period) as the control input VDSET of the power switch controller 418. Hence, the high-side power switch UG is periodically turned on at a fixed clock rate under the CB mode.

The on-time generator 408 is configured to generate a control input VRST to the power switch controller 418. The control input VRST determines the turn-off time of the high-side power switch UG and the turn-on time of the low-side power switch LG. Specifically, the on-time T_{ON} of the high-side power switch UG is defined by the control input VDSET and the control input VRST. For example, the on-time generator 408 may include a current source 420, multiple capacitors (e.g., C1, C2, and C3), multiple switches (e.g., SW1 and SW2), and a comparator 422. The current source 420 provides a reference current α(V_{IN}−V_{OUT}). The ON/OFF state of each of the switches SW1 and SW2 is controlled by the COT control setting CS1. When the COT control setting CS1 is set by a maximum COT control value, both of the switches SW1 and SW2 are turned on, resulting in a longest charge time of the voltage V_{C}. When the COT control setting CS1 is set by a minimum COT control value, both of the switches SW1 and SW2 are turned off, resulting in a shortest charge time of the voltage V_{C}. When the COT control setting CS1 is set by a medium COT control value, only one of the switches SW1 and SW2 is turned on, resulting in a medium charge time of the voltage V_{C}. When the voltage V_{C} is lower than a reference voltage V_{REF} CIP, the control input VRST has a logic high level, the high-side power switch UG is not turned off, and the low-side power switch LG is not turned on. However, when the voltage V_{C} increases above the reference voltage V_{REF} CIP, the control input VRST has a logic low level, the high-side power switch UG is turned off, and the low-side power switch LG is turned on.

The comparator 410 compares the voltage V_{LX} and the ground voltage GND to set the comparator output ZC. The comparator output ZC decides the turn-off time OFF_{LG} of the low-side power switch LG. Specifically, when the voltage V_{LX} reaches the ground voltage GND, the comparator output ZC is set to indicate that the low-side power switch LG should be turned off. When the CB mode is inactive (i.e., CB_MODE=0), the controllable delay circuit 414 bypasses the comparator output ZC to the power switch controller 418 without applying any delay time to the comparator output ZC. When the CB mode is active (i.e., CB_MODE=1), the controllable delay circuit 414 applies a delay time T_{D} to the comparator output ZC before the comparator output ZC arrives at the power switch controller 418. In other words, the turn-off time OFF_{LG} of the low-side power switch LG is delayed by the controllable delay circuit 414 under the CB mode. The delay time T_{D} is controlled by the delay time control setting CS2.

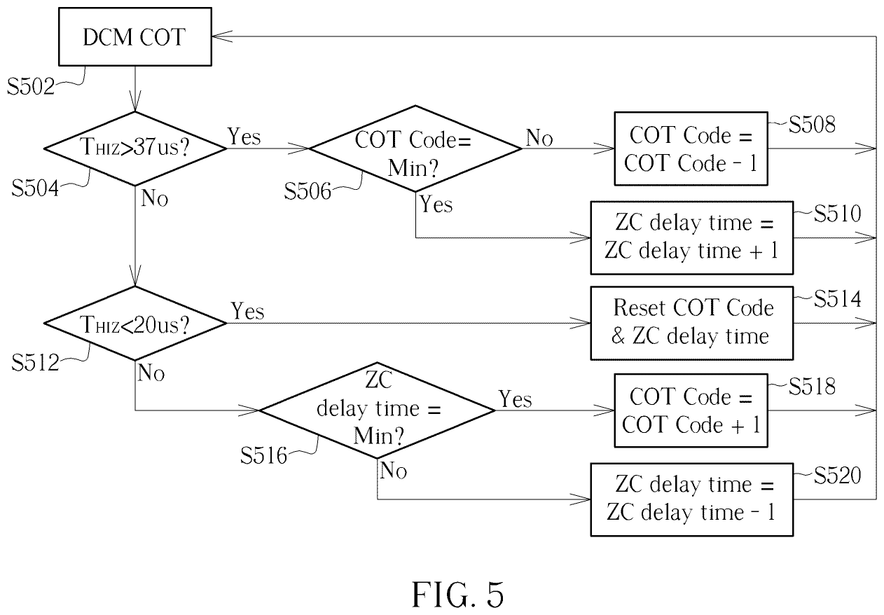

Please refer to FIG. 5 in conjunction with FIG. 4. FIG. 5 is a flowchart illustrating a method for controlling a switching regulator according to an embodiment of the present invention. For example, the method may be employed by the controller circuit 400 shown in FIG. 4. Provided that the result is substantially the same, the steps are not required to be executed in the exact order shown in FIG. 5. In step S502, the controller circuit 400 performs ACOT control under DCM. In step S504, the decision circuit 406 checks if the HiZ time T_{HIZ} between the previous regulation operation and the current regulation operation is longer than a threshold value TH1 (e.g., TH1=37 us). If the HiZ time T_{HIZ} is longer than the threshold value TH1 (e.g., TH1=37 us), meaning that the switching frequency F_{SW} is close to an upper bound of the audio frequency band, the decision circuit 406 checks if the COT control setting CS1 is assigned the minimum COT control value (step S506). If the COT control setting CS1 is not yet assigned the minimum COT control value, the decision circuit 406 instructs the COT setting circuit 402 to decrease the COT control setting CS1 (e.g., COT Code=COT Code−1) for decreasing the positive peak current Iₚₑₐₖ of the current regulation operation (step S508). If the COT control setting CS1 is assigned the minimum COT control value, the decision circuit 406 instructs the delay time setting circuit 404 to increase the delay time control setting CS2 (e.g., ZC delay time=ZC delay time+1) for increasing the negative peak current I_{NEG} of the current regulation operation (step S510).

If step S504 judges that the HiZ time T_{HIZ} between the previous regulation operation and the current regulation operation is not longer than the threshold value TH1 (e.g., TH1=37 us), the flow proceeds to step S512. In step S512, the decision circuit 406 checks if the HiZ time T_{HIZ} between the previous regulation operation and the current regulation operation is shorter than a threshold value TH2 (e.g., TH2=20 us). If the HiZ time T_{HIZ} is shorter than the threshold value TH2 (e.g., TH2=20 us), meaning that the load device suddenly becomes a heavy load requiring large power, the decision circuit 406 instructs the COT setting circuit 402 to reset the COT control setting CS1, and instructs the delay time setting circuit 404 to reset the delay time control setting CS2. In step S514, the COT setting circuit 402 resets the COT control setting CS1 to the maximum COT control value allowed by the switching regulator 100 for selecting the maximum positive peak current for the current regulation operation, and the delay time setting circuit 404 resets the delay time control setting CS2 to the minimum delay time control value allowed by the switching regulator 100 for selecting the minimum negative peak current I_{NEG} (e.g., I_{NEG}=0 mA) for the current regulation operation.

If step S512 judges that the HiZ time T_{HIZ} is not shorter than the threshold value TH2 (e.g., TH2=20 us), implying that the HiZ time T_{HIZ} is between the threshold values TH1 and TH2, the flow proceeds to step S516. In step S516, the decision circuit 406 checks if the delay time control setting CS2 is assigned the minimum delay time control value. If the delay time control setting CS2 is assigned the minimum delay time control value, the decision circuit 406 instructs the COT setting circuit 402 to increase the COT control setting CS1 (e.g., COT Code=COT Code+1) for increasing the positive peak current Iₚₑₐₖ of the current regulation operation (step S518). Specifically, iteration of step S518 makes the positive peak current Iₚₑₐₖ gradually approach the maximum positive peak current. If the delay time control setting CS2 is not yet assigned the minimum delay time control value, the decision circuit 406 instructs the delay time setting circuit 404 to decrease the delay time control setting CS2 (e.g., ZC delay time=ZC delay time−1) for decreasing the negative peak current I_{NEG} of the current regulation operation (step S520). Specifically, iteration of step S520 makes the negative peak current I_{NEG} gradually approach the minimum negative peak current.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A controller circuit of a switching regulator, comprising:
a constant on-time (COT) setting circuit, configured to adaptively adjust a COT control setting, wherein an on-time of a high-side power switch of the switching regulator depends on the COT control setting; and
a delay time setting circuit, configured to adaptively adjust a delay time control setting during a period in which the COT control setting is assigned a minimum COT control value allowed by the switching regulator, wherein a delay time applied to a turn-off time of a low-side power switch of the switching regulator depends on the delay time control setting.

2. The controller circuit of claim 1, further comprising:
a decision circuit, configured to check if a High-Z (HiZ) time between a previous regulation operation and a current regulation operation is longer than a threshold value;
wherein when the HiZ time is longer than the threshold value, one of the COT control setting and the delay time control setting is adjusted.

3. The controller circuit of claim 2, wherein the HiZ time is longer than the threshold value, and the COT setting circuit is configured to decrease the COT control setting when the COT control setting is not yet assigned the minimum COT control value.

4. The controller circuit of claim 2, wherein the HiZ time is longer than the threshold value, and the delay time setting circuit is configured to increase the delay time control setting when the COT control setting is assigned the minimum COT control value.

5. The controller circuit of claim 1, further comprising:
a decision circuit, configured to check if a High-Z (HiZ) time between a previous regulation operation and a current regulation operation is shorter than a threshold value;
wherein when the HiZ time is shorter than the threshold value, both of the COT control setting and the delay time control setting are adjusted.

6. The controller circuit of claim 5, wherein the HiZ time is shorter than the threshold value, the COT setting circuit is configured to reset the COT control setting to a maximum COT control value allowed by the switching regulator, and the delay time setting circuit is configured to reset the delay time control setting to a minimum delay time control value allowed by the switching regulator.

7. The controller circuit of claim 1, further comprising:
a decision circuit, configured to check if a High-Z (HiZ) time between a previous regulation operation and a current regulation operation is longer than a first threshold value, and further configured to check if the HiZ time between the previous regulation operation and the current regulation operation is shorter than a second threshold value;
wherein when the HiZ time is not longer than the first threshold value and is not shorter than the second threshold value, one of the COT control setting and the delay time control setting is adjusted.

8. The controller circuit of claim 7, wherein the HiZ time is not longer than the first threshold value and is not shorter than the second threshold value, and the COT setting circuit is configured to increase the COT control setting when the delay time control setting is assigned a minimum delay time control value allowed by the switching regulator.

9. The controller circuit of claim 7, wherein the HiZ time is not longer than the first threshold value and is not shorter than the second threshold value, and the delay time setting circuit is configured to decrease the delay time control setting when the delay time control setting is not yet assigned a minimum delay time control value allowed by the switching regulator.

10. The controller circuit of claim 1, wherein the delay time setting circuit is configured to periodically adjust the delay time control setting during the period in which the COT control setting is assigned the minimum COT control value.

11. A method for controlling a switching regulator, comprising:
adaptively adjusting a constant on-time (COT) control setting, wherein an on-time of a high-side power switch of the switching regulator depends on the COT control setting; and
adaptively adjusting a delay time control setting during a period in which the COT control setting is assigned a minimum COT control value allowed by the switching regulator, wherein a delay time applied to a turn-off time of a low-side power switch of the switching regulator depends on the delay time control setting.

12. The method of claim 11, further comprising:
checking if a High-Z (HiZ) time between a previous regulation operation and a current regulation operation is longer than a threshold value; and
in response to the HiZ time being longer than the threshold value, adjusting one of the COT control setting and the delay time control setting.

13. The method of claim 12, wherein adjusting one of the COT control setting and the delay time control setting comprises:
in response to the COT control setting being not yet assigned the minimum COT control value, decreasing the COT control setting.

14. The method of claim 12, wherein adjusting one of the COT control setting and the delay time control setting comprises:
in response to the COT control setting being assigned the minimum COT control value, increasing the delay time control setting.

15. The method of claim 11, further comprising:
checking if a High-Z (HiZ) time between a previous regulation operation and a current regulation operation is shorter than a threshold value; and
in response to the HiZ time being shorter than the threshold value, adjusting both of the COT control setting and the delay time control setting.

16. The method of claim 15, wherein adjusting both of the COT control setting and the delay time control setting comprises:
resetting the COT control setting to a maximum COT control value allowed by the switching regulator; and
resetting the delay time control setting to a minimum delay time control value allowed by the switching regulator.

17. The method of claim 11, further comprising:
checking if a High-Z (HiZ) time between a previous regulation operation and a current regulation operation is longer than a first threshold value;
checking if the HiZ time between the previous regulation operation and the current regulation operation is shorter than a second threshold value; and
in response to the HiZ time being not longer than the first threshold value and not shorter than the second threshold value, adjusting one of the COT control setting and the delay time control setting.

18. The method of claim 17, wherein adjusting one of the COT control setting and the delay time control setting comprises:
in response to the delay time control setting being assigned a minimum delay time control value allowed by the switching regulator, increasing the COT control setting.

19. The method of claim 17, wherein adjusting one of the COT control setting and the delay time control setting comprises:
in response to the delay time control setting being not yet assigned a minimum delay time control value allowed by the switching regulator, decreasing the delay time control setting.

20. The method of claim 11, wherein the delay time control setting is periodically adjusted during the period in which the COT control setting is assigned the minimum COT control value.
